(19) United States
(12) Patent Application Publication
(10) Pub. No.: US 2015/0324597 A1
(43) Pub. Date: Nov. 12, 2015

(54) A SYSTEM FOR PROTECTION OF EMBEDDED SOFTWARE CODES

(71) Applicant: KPIT TECHNOLOGIES LTD., Hinjewadi, Pune ,Maharashtra (IN)

(72) Inventors: Vinay G. VAIDYA, Pune (IN); Kaushik L. SHAH, Pune (IN); Nishant N. THOLIYA, Pune (IN); G. SRIRAM, Pune (IN)

(21) Appl. No.: 14/236,578

(22) PCT Filed: Jul. 27, 2012
(86) PCT No.: PCT/IN2012/000527

§ 371 Date: Jan. 31, 2014

(30) Foreign Application Priority Data
Aug. 5, 2011 (IN) 3180/MUM/2010

(51) Int. Cl. G06F 21/62; G06F 21/85

(52) U.S. Cl. CPC G06F 21/6218; G06F 21/85

(57) ABSTRACT

A system for securing embedded software codes having an industrial application from unauthorized access and use is disclosed. The system for code security according to the present invention provides protection for embedded software codes implemented in an automated application. According to the disclosed invention, the code is divided into plurality of segments and parts of the algorithm are distributed and executed in multiple environments, thereby preventing hacking of the code.

### FIELD OF INVENTION

The invention relates to a system having an industrial application for protection of software code embedded in a hardware device from hacking and unauthorized access. This invention further relates to a method for securing the embedded software code in various automated systems.

### BACKGROUND OF INVENTION

Protection of application codes from hacking is of primary importance for any software application. An unsecure application code is always at the risk like being hacked, tampered with or decoded by reverse engineering. A source code which is hacked, tampered with or decoded can severely affect the applications in which it is used and hence may also damage the device in which it is being used.

Currently, a variety of off-the-shelf solutions are provided by different manufacturers for protection of the software codes embedded in various applications. Various secured codes and devices are available in the market to protect the application code. However, in practice, most of the available secured codes are eventually hacked using various techniques. The existing systems for code protection are not robust and are eventually compromised. Hence, there is a need for a system for code protection which is robust and can protect the application code under various circumstances.

Currently, the use of electronics and software in automotive applications has increased many folds. With the growing demand for advanced driver assistance functionalities and features in automobiles, the use of software and embedded applications in automotive or any automated applications has also augmented significantly. Software and embedded solutions are progressively being used in a variety of applications in automotive parts like the power trains, electronic control units (ECU), engine controls, control functions for braking, guidance systems, audio and video equipments, etc. With increasing use of software and the application codes in automotive applications, the protection and security of these codes has hence become the primary concern. Therefore, there is need for a method for providing protection to various software codes in automotive applications from the threat of tapping, tampering, decoding, hacking and such similar intrusive threats.

One way of keeping the application secure and inaccessible to hackers is to split the code within two working environments which has been attempted by SIGBJORNSEN, Sigurd et al vide US Patent Application No. US 2004/0193987.

Yet another attempt is disclosed in US 2004/0098613, whereby the code is split in two portions and wherein a portion of code is placed in one device while other portion is stored in a connectable protected device. The either devices, as per disclosure, comprise a set of instruction which cannot be executed without calling functions on other processor.

The above mentioned methods are not robust since, smart cards, as used in US '987, can now be hacked and thereby compromising security. While in case of US '613 there is always a possibility that the connectable protected device may be corrupted by a viral program or damaged or corrupted due to environmental factors.

Hence, there is need for a robust system for providing protection to various embedded codes in automated applications from the threat of tapping, tampering, decoding, hacking and such other similar threats.

In view of the above, the present invention proposes a novel system for securing the embedded software application for automated systems by dynamic distribution and execution in different environments.

### SUMMARY

The invention provides for a system to protect the software codes embedded in different automated applications from unauthorized access. The present invention comprises of a security device connected to an automated system and its control logic via a communication bus.

In an aspect, the invention provides a system for robust security of the software codes embedded in the automated system, wherein the system comprises a provision for the code to destroy itself in case of an attempt to steal, tamper with, reverse engineer or hack the code.

### BRIEF DESCRIPTION OF THE DRAWING

FIG. 1 illustrates a block diagram for a system for protection of embedded software codes according to the present invention.

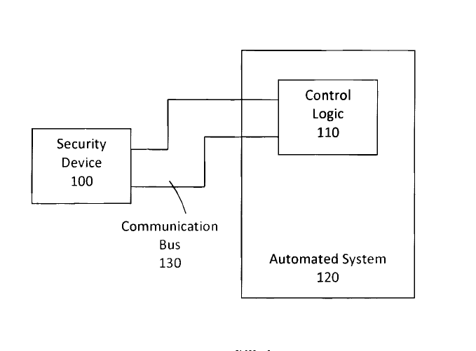

As illustrated in FIG. 1, the system according to the present invention comprises an automated system 120, which includes control logic 110 comprising the code and a security device 100 connected to the control logic 110 over a communication bus 130 to prevent unauthorized access.

### DETAILED DESCRIPTION

Various automated systems provide devices having functionalities that include various software codes and/or embedded applications that constitute algorithms, codes, data and instruction sets. The security of these codes is of utmost importance in order to protect them from being hacked into, which could result in the application code being tampered with or re-engineered causing damage to the application and possibly to the device itself. Hence the system of the present invention provides for securing the embedded software codes of an automated system.

As illustrated in FIG. 1, an embodiment of the present invention comprises of an automated system (120), having its own control logic (110), which includes the embedded software codes and a security device 100 connected to the control logic (110) over a communication bus (130) to prevent unauthorized access.

In an embodiment, the system of invention comprises security device (100) facilitating the division of the embedded software code into a plurality of user defined segments for the -distribution and execution in plurality of environments such as that of the control logic (110) and the security device (100). The communication bus (130) facilitates transmission of the plurality of segments of the embedded code at a fast speed. The encrypted data is transmitted over the communication bus 130 and is de-encrypted at the receiving end. The security device (100) and the control logic (110) may be connected over any network which facilitates data transfer at a fast speed. The calibration data in the security device 100 is set via a calibration tool. Various sensors may be used as an input interface to the system. The user/programmer distributes segments of the embedded software code between the security device (100) and the control logic (110), based on the security requirement of a particular application, which are then frozen into the system. In an optional embodiment, in case of detection of tamper or attempt to tamper, a watch dog may be provided for erasing the encryption and the decryption as per the requirement.

In an embodiment, the division and execution of the software codes is facilitated in different controllers and hence different environments, thereby preventing the code from being hacked. The core code, the data and the instruction set are all distributed into user-defined segments and executed in the two different environments of the control logic (110) and the security device (100). Various handshake protocols known in the art may be utilized for co-coordinating the distribution and execution of the plurality of segments of the embedded applications. In an embodiment, the system of the invention is provided with provisions wherein the application code destroys itself in case of an attempt of stealing, tampering, breaking or disconnection of the communication bus or any such similar activity of hacking.

In an embodiment, the system comprises a security device (100) which is selected from a dongle, hardware token or any other such similar device which can be connected to the control logic (110). The said control logic (110) may be selected from various processors and controllers known in prior art, as per the requirement of the software application. Said security device (100) and said control logic (110) are connected over a communication bus (130), whereby communication bus can be any network or bus which facilitates data transfer at a fast speed, preferably CAN Bus. Instructions to be executed by the security device (100) may be obtained from the control logic (110) and vice-versa.

In a preferred embodiment, by means of the said security device (100), a user splits the embedded software codes in different segments, based on the application requirements. The said segments are then transmitted during the boot of the automated system over the communication bus (130), such that the code is distributed between the control logic (110) and security device (100). The code is then executed in different environments of the security device (100) and control logic (110). Instructions for program execution at the security device (100) are fetched from the memory of the control logic while instructions for the control logic (110) are fetched from the memory of the security device.

The security device (100) and the control logic (110) may include various processors and controllers as per the requirement of the software application. In case of any hacking, tampering or intrusion, the segments of code being transmitted over the communication bus (130) destroy themselves either at the security device (100) end or the control logic (110) end or at both the ends.

Additionally, the system of the present invention for securing embedded software code from an unauthorized access may be utilized for any applications which include use of software and embedded applications and hence software codes which need to be secured. As per the requirement, the core algorithm may also be distributed and executed in not only two different controllers but multiple different controllers and hence multiple different environments. The system of the invention is generic enough to find applications in every case where the manufacturers do not provide any security feature. The method as described above is exemplified with following applications;

### Application 1:

### Scenario:

In a hybrid vehicle, a controller contains vital source codes regarding the control of usage of the engine and the motor. Additionally, the monitoring and optimum utilization of energy devices in the hybrid vehicle is also controlled by the various source codes contained in the controller of the vehicle. As such, the controller contains all the key source codes required for increasing the fuel efficiency and hence the performance of the hybrid vehicle. However, most of these controllers that are available in the market are manufactured by some third parties thus making it impossible to have the security access of the codes contained in the controller.

### Strategy:

According to the present invention, the plurality of segments of the embedded applications may be distributed between the security device and the micro-controller, may be a motor controller, of the hybrid vehicle and executed in two different environments, thus providing the required protection.

### Application 2:

### Scenario:

Washing machine spin logic differentiates between competitions and needs to be protected from reverse engineering.

### Strategy:

One may have two microcontrollers communicating with each other over the bus (CAN/SPI). Primary responsibilities of one of the microcontroller could be spin logic, and other microcontroller could be controlling motor.

One will have proprietary encrypted protocol between these two controllers sharing key parameters. Parameters processing required for spin logic would be distributed to both microcontrollers and shared over each other with proprietary protocol which would be encrypted. For example, the user may split the embedded application code into a spin logic code and a washing functionality code which could be transmitted into the security device (100), while a rinsing code and a drying code could be transmitted into the control logic (110).

With this kind of mechanism, in case of an attempt to replicate, copy software/hardware, it will be very difficult for the offender to reverse engineer the working logic of spin, which would be the core algorithm protected according to the embodiments of the present invention.

### Application 3:

### Scenario:

SOC, SOH code which are proprietary and manufacturer would like to secure these codes.

### Strategy:

One may have two microcontrollers communicating with each other over the bus (CAN/SPI).

Primary responsibilities of one of the microcontroller could be determination of SOC and SOH, and other microcontroller could be responsible for data acquisition of battery parameters.

The proprietary encrypted protocol is shared between these two controllers. Parameters processing requires implementing SOC and SOH algorithm would be distributed to both microcontrollers and shared by a proprietary protocol which would be encrypted.

With system, as discussed herein, if there is an attempt to replicate, copy software/hardware, it will be very difficult for the offender to reverse engineer the logic of SOC, SOH, which would be the core code protected according to the embodiments of the present invention.

The examples shown in the embodiments of the invention as described hereinabove and read along with illustration in FIG. 1, in no way limit the applicability of the present invention to them and as such a person skilled in art may modify the embodiments without departing from the scope of invention. While the invention is not related to algorithms or software codes, the invention provides protection and security to algorithms and software codes in modes that are increasingly threatened in the industrial and commercial environs due to criminal and illegal acts such as hacking, tampering, espionage, intruding, Reverse engineering, etc. The present invention acts a security device against such illegal acts and electronic thefts which are increasingly rampant in the industrial market place.

1. A system for protection of embedded software codes comprising:
a. a security device and a control logic to store the embedded software codes into a plurality of user defined segments, wherein, instructions for code execution at the said security device are fetched from a memory of the control logic and vice versa;
b. a communication bus that connects the security device to the control logic over which a plurality of segments of the said embedded codes and data are transmitted at a fast speed;
and
c. an automated system, that includes the control logic, being connected to the security device via the communication bus to facilitate distribution of the embedded software code and execute the same in a plurality of environments wherein, the embedded software codes destroy themselves in case of any tampering, stealing, breaking or disconnection of the communication bus.

2. The system as claimed in claim 1, wherein the segments of the software code embedded in the automated system destroy themselves at the security device end in case of an attempt of stealing, tampering, breaking or disconnection of the communication bus.

3. The system as claimed in claim 1, wherein the software codes embedded in the automated system are encrypted and transmitted at a fast speed.

4. The system as claimed in claimed 1, wherein said user defined segments are transmitted during the boot of the system over the communication bus such that the code is distributed between the control logic and the security device.

5. The system as claimed in claim 2, wherein the security device is selected from a dongle or hardware token.

6. The system as claimed in claim 1, wherein the communication bus is a CAN bus.

7. The system as claimed in claim 2, wherein the system further comprises a watch dog timer for erasing the encryption and the decryption.
